(19) United States
(12) Patent Application Publication
(10) Pub. No.: US 2010/0024689 A1
(43) Pub. Date: Feb. 4, 2010

(54) PALLET WITH COMPOSITE COMPONENTS

(75) Inventor: Terry L. INGHAM, Oxford, MI (US)

Correspondence Address: HARNESS, DICKEY & PIERCE, P.L.C., P.O. BOX 828, BLOOMFIELD HILLS, MI, 48303, US

(73) Assignee: FITZPATRICK TECHNOLOGIES, LLC, Oxford, MI (US)

(21) Appl. No.: 12/564,443

(22) Filed: Sep. 22, 2009

Related U.S. Application Data
(63) Continuation of application No. 11/277,560, filed on Mar. 27, 2006.
Application No. 11/277,560 is a continuation-in-part of application No. 11/184,709, filed on Jul. 19, 2005, now abandoned.

(51) Int. Cl. B65D 19/38; D21B 1/04; B29B 9/12

(52) U.S. Cl. 108/57.17; 264/115; 264/118

(57) ABSTRACT

A pallet having a first deck, a second deck, and a plurality of composite block members securing the first and second decks together to form a pallet. The composite block members and lead boards of the first and/or second deck comprise a composite material including about 50%-55% by weight of juniper or conifer particles and about 45%-50% by weight of a plastic component including a major portion of polyethylene.

### CROSS-REFERENCE TO RELATED APPLICATIONS

This application is a continuation of U.S. patent application Ser. No. 11/277,560 filed on Mar. 27, 2006, which is a continuation-in-part of U.S. patent application Ser. No. 11/184,709 filed on Jul. 19, 2005, now abandoned.

### FIELD

The present disclosure relates to a pallet, and more particularly, a pallet having recycled components.

### BACKGROUND

The common wooden and plastic industrial pallets are generally known in the art. Such pallets, however, have several shortcomings in regards to cost, quality, limitations of their use, and ease of manufacture. Wooden pallets are typically constructed by sandwiching wooden block members between two similar decks or surfaces. Since the aesthetic appearance of pallets may not outweigh the cost, they may often include scrap or recycled wood. The surfaces may be made of a continuous sheet or, more commonly, have a plurality of wooden boards typically arranged in a parallel manner. Generally, the surfaces and blocks are stacked or arranged to provide apertures suitable for access by the tines of a forklift truck or pallet jack from at least one side. In certain instances, the tines of a fork-lift truck make contact with the block members during alignment. If the force is significant, the block members can be damaged.

By its nature, ordinary wood may be subject to swelling, warping, shrinkage, splintering, deterioration and fungal or bacterial growth after exposure to moisture and other elements. Pallets assembled with inferior quality wood blocks and/or boards may lead to potential cargo damage.

Attempts to overcome the drawbacks of ordinary wooden pallets with plastic pallets have been faced with similar shortcomings. Prior designs of plastic pallets have had to deal with issues such as the trade off between cost and weight bearing capability. Typically, plastic pallets designed with a significant weight bearing capability have tended to be both heavy and expensive. In the same manner, inexpensive plastic pallets have had both strength and durability issues.

In recent times, society has expended significant efforts on continuing the development of more environmentally-friendly methods for reusing various synthetic and plastic materials. It is therefore desirable to provide a long-life pallet at least partially derived from recycled components and having outstanding physical attributes that is relatively inexpensive and can be manufactured with relative ease. Specifically, it is desirable to provide a low cost pallet that meets and exceeds stringent strength and design standards.

### SUMMARY

The present disclosure provides a pallet having an upper deck and a lower deck. The upper deck comprises a first plurality of cross members and a lead board. The lower deck comprises a second plurality of cross members. A plurality of block members is provided connecting the upper and lower decks together to form a pallet. At least one block member, the lead board, and at least one cross member of the first or second plurality of cross members comprise a composite material including at least about 50% by weight of a natural material and at least about 45% by weight of a plastic material comprising a major portion of polyethylene.

The present disclosure also relates to method of making a pallet member. The method includes receiving wood particles on a screen and screening out wood particles of a given size. The screened wood particles are transported to a reducer for reducing the size of the screened wood particles. The wood particles are then transported to a washer for washing the wood particles. The washed wood particles are flaked and then sent for grinding and storing the wood particles in a processed wood receiver. A plastic material is stored in a plastics receiver. The method includes transporting the plastic material from the plastics receiver and the wood particles from the wood receiver to a blender for blending the plastic material and wood particles. Blended wood particles and plastic material are formed into a pallet component using heat and pressure.

In another embodiment, a method of making a pallet is provided including preparing and blending a mixture comprising from about 50% to about 55% by weight of natural material particles and from about 45% to about 50% by weight of plastic material particles. The method includes heating and extruding the mixture using a continuous extrusion process forming a composite material of a desired shape. The composite material is then cut into block members and boards. The method proceeds with securing the blocks and boards with nails or screws to form a pallet having substantially rectangular shaped upper and lower decks.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a perspective view of a pallet in accordance with teachings of the present disclosure;

FIG. 2 is an exploded perspective view of a pallet according to the present disclosure and showing individual components thereof;

FIG. 3 is a perspective view of a first block member comprising recycled material according to the present disclosure;

FIG. 4 is a top view of the block member of FIG. 3;

FIG. 5 is a side view of the block member of FIG. 3;

FIG. 6 is a perspective view of a second block member according to the present disclosure;

FIG. 7 is a top view of the block member of FIG. 6;

FIG. 8 is a side view of the block member of FIG. 6;

FIG. 9 is a perspective view of a third block member according to the present disclosure;

FIG. 10 is a side view of the block member of FIG. 9;

FIG. 11 is a top view of the block member of FIG. 9;

FIG. 12 is a perspective view of a fourth block member according to the present disclosure;

FIG. 13 is a top view of the block member of FIG. 12;

FIG. 14 is a side view of the block member of FIG. 12; and

FIG. 15 is a perspective view of a fifth block member according to the present disclosure.

It should be noted that the figures set forth herein are intended to exemplify the general characteristics of an apparatus, materials, and methods among those of this disclosure, for the purpose of the description of such embodiments herein. These figures may not precisely reflect the characteristics of any given embodiment, and are not necessarily intended to define or limit specific embodiments within the scope of this disclosure.

### DETAILED DESCRIPTION

The following description of the present disclosure is merely exemplary in nature and is in no way intended to limit the disclosure, its application, or uses. For purposes of clarity, it should be understood that throughout the drawings, corresponding reference numerals indicate like or corresponding parts and features.

In various embodiments, the present disclosure provides a pallet including a first deck, a second deck and a plurality of block members connecting the first and second decks together. The block members, and optionally certain boards or cross members of the decks, may comprise a high strength composite material including at least one recycled thermoplastic component, preferably including at least 20% by weight of a recycled nylon carpet material. The recycled nylon carpet material particles may be present in an amount up to about 50% by weight, or up to about 75% or even 90% by weight, including a major portion of nylon 6 and/or nylon 6,6 depending on the specific design. In various embodiments, such nylon material is provided in an amount from about 80% to about 85% by weight. The composite material has excellent resistance to chemicals, including strong solvents, and is not moisture or odor absorbent. Such composite blocks and/or cross member boards containing recycled materials according to the present disclosure are robust and rugged in construction, configured to withstand the weight of goods stacked on them and to withstand the impact of truck forks driven into them as a result of misalignment. A pallet comprising such composite material also has the capability of being fitted with RFID technology.

Various conventional nylon based carpeting useful with the present disclosure typically includes at least three primary components, namely a plurality of tufts formed from nylon, at least one backing typically formed from polyolefins such as polypropylene, and an adhesive material applied as a latex and typically filled with an organic filler such as calcium carbonate. In various embodiments, the nylon tufts include a major portion of nylon 6; nylon 6,6; or blends or copolymers thereof. While this multi-component carpet product may present challenges to typical recycling efforts due to the varying chemical and physical characteristics of its individual components in different forms, such nylon containing carpet, both new and used, is useful in the preparation of a composite material for use in a pallet according to the present disclosure. If desired, various methods are known in the art useful for converting an “unseparated” carpet into a thermoplastic material formed from a melt blend of the materials which originally comprised the carpet. For example, U.S. Pat. No. 5,294,384 to David et al. which is incorporated herein by reference in its entirety, discloses a process for forming a thermoplastic composition from carpet wherein a carpet sample is melted and blended without separating the carpet into its various parts.

The composite material may also include various plastic materials in addition to that in the recycled nylon carpet. As used herein, “plastic material” includes, but is not limited to, plastic materials suitable for use in a high strength composite material for a pallet, such as thermoplastic polymers resistant to many chemical solvents, bases and acids, for example, polypropylene, polyethylene, polyurethane, polyvinylchloride, and poly(ethylene terephthalate). The plastic material may also include various types and grades of nylon, such as nylon 6 and nylon 6, 6. Recycled nylon can be obtained from many industrial type sources, for example from automotive uses, such as nylon gears; rubber textiles; and rubber fabrics. The plastic may be selected depending on the specific pallet design, load capacity, and other requirements. In various embodiments, the block members may be manufactured with either recycled components alone or combination with at least one prime or virgin material. Thus the composite material may include various grades of virgin plastic, recycled plastic, and mixtures thereof.

In various embodiments, the composite material of the present disclosure comprises at least 20% by weight of recycled nylon carpet material. In one embodiment, the composite material includes a major portion of nylon 6 and nylon 6,6, for example up to about 50% by weight, in some embodiments, up to about 80% by weight. According to other embodiments detailed below, the composite material may comprise greater than about 20% by weight of natural material particles, or greater than about 50% by weight, or even greater than 80% by weight. It should be understood that all weight percentages described herein can be increased or decreased between 0% and 100% for a desired composite material, depending on the specific design and selection of materials, and these variations are within the scope of the present disclosure.

In various embodiments, the composite material may further include at least one ground recycled material selected from the group consisting of bottling containers, automotive rubber and plastic components, agricultural films, rubber and rubber tires, fabrics, textiles, reclaimed paper, sanitary paper products, and mixtures thereof. In various embodiments, the block members may be manufactured with such recycled components alone or combination with at least one prime or virgin material. In most instances, the recycled materials are shredded prior to use, as opposed to being in their original size and shape. Shredding would include any type of cutting, grinding, chopping, or other reducing operation that cuts or tears apart recyclable materials, or any portion thereof, to create smaller pieces for use in the composite material of the present disclosure.

As used herein, bottling containers may include typical recycled fluorinated plastic containers or PET type containers including, for example, those commonly used to store and/or transport various liquids. Automotive rubber and plastic components may include any and all suitable recyclable materials derived from automobiles and/or automotive equipment. Rubber includes industrial rubber compounds, such as those typically derived from polystyrene, polybutadiene, and poly(styrene-butadiene-styrene) or SBS. “Rubber tires” generally refers to vehicular tires of the type used by automobiles, tractors, etc.

As used herein, an “agricultural film” generally includes, but it not limited to, a film formed from polyvinyl chloride (PVC), polycarbonate (PC), a polyethylene thermoplastic resin, such as polyethylene (PE), low density polyethylene (LDPE), or an ethylene-vinyl acetate copolymer, or other such suitable films formed from a polyester resin that may be used for forming, for example, a greenhouse or a plastic tent, since such films exhibit excellent transparency, heat-insulating ability, and mechanical strength. These resin type films typically cannot be used for their intended purpose for a long period of time because of deterioration caused by UV rays, for example, impairment of transparency or breakage of the film. Thus, they may be suitably cleaned and shredded prior to being used in the recycled composite material of the present invention.

The composite material may also include paper stock, reclaimed “waste” paper (so-called recycled papers), de-inked paper stock, paper shavings or cuttings, and the like. The reclaimed papers may be shredded and included “as-is” or may otherwise be mechanically disintegrated in water to produce a pulp suspension, after which foreign materials may be removed. De-inked paper stock may be used from printed and/or unprinted reclaimed papers by means of mechanical disintegration, and may be treated with chemicals and dispersing agents. In general, certain secondary pulps may be of shorter fiber length and somewhat lower in strength than the original pulp; therefore, they may be used either alone or combination with prime or virgin fibers. Paper shavings and cuttings (e.g., from binderies) may also be used.

In various embodiments, the composite material may include recycled sanitary paper products. As used herein, “sanitary paper products” may include various absorbent sanitary products, such as disposable baby diapers, that can be separated into such products suitable for use as a recycled material. Numerous treatment processes for recovering usable portions of such items are known in the art. For example, U.S. Pat. No. 5,558,745 to Conway et al. discloses a treatment process for separating components suitable for recycling from absorbent sanitary papers products and is incorporated herein by reference in its entirety.

As previously discussed, the composite material of the present disclosure may include a natural material, such as wood, its shavings, or mulch in addition to the recycled nylon carpet and other materials. As used herein, a “natural material” typically includes wood, for example, material from a tree, including but not limited to leaf material, branch material, trunk material, bark material, needle material, and root material. As used herein, the term “wood” includes, but is not limited to, any hard and soft wood trees, and includes wood particles, fibers, strands, dust, scraps, and products made there from. The wood particles used in the present disclosure may be elongated shapes having a width or average particle size that is about ¼ (0.25) inch or less. In various embodiments, the width is 1/16 (0.0625) inch or less, and even more preferably, 1/32 (0.03125) inch or less. It should be understood that the average particle size can be increased or decreased, depending on the specific design and selection of materials, and these variations are within the scope of the present disclosure. It should further be noted that the average particle size is not based on the total number of particles but rather is based on the weight percentage of the material retained in measuring sieve trays in relation to the total sieved material weight. Natural material particles often have unequal dimensions, for example a length greater than a width. In such circumstances, a particle size refers to at least one dimension having the specified size. Particle size distribution can be determined using Gaussian distribution, or other methods known in the art.

Optional non-limiting additives for the composite material may include colorants, UV protectors, flame and fire retardants, lubricants, soaps, various inert fillers, reinforcements (including, for example, natural, synthetic, and glass fibers), polymerization initiators, coupling agents, and other additives known in the art. Foaming agents may also be used to reduce overall mass and save on raw materials and weight. Additionally, the composite material is recyclable to itself as filler. In particular, the use of coupling agents in the composite matrix may improve thickness swell and increase the resistance to UV exposure and surface popping. Coupling agents increase the bond between the natural and plastic materials which typically increases the stiffness and strength by up to about 30%. Alternatively, if it is not desirable to use a coupling agent, the average particle size can be slightly decreased to maintain an equivalent strength.

In certain embodiments, and preferably where the composite material is used to manufacture sheet boards that are subsequently cut into lead boards, it may be desirable to use larger size recycled particles and include the use of reinforcing natural or wood fibers. Such fibers may be used having an average length of about ⅜ inch, ½ inch, ¾ inch, or even greater as desired. In various embodiments, it may also be desirable to include continuous, uni-directional reinforcing fibers, such as silicon-based fiberglass or other inorganic or organic fibers. These continuous fibers would extend substantially parallel to and run along with the direction of the cross-members to provide additional strength.

The wood particles may be processed in a hammer mill using a desired screen size. This enables distribution of the wood material product in a substantially even manner for use with the recycled components in the composite material. In various embodiments, the particles have a random orientation in the final product, although with some embodiments using extrusion techniques it may be desired to have a process-specific orientation. Further, if reinforcing fibers are used, it may be desired to align the fibers for increased strength.

The manufacture of the composite material of the present disclosure into various geometries is preferably achieved using typical press methods, compression, injection molding, and/or extrusion techniques known in the art. Typically, any wood or natural materials are first passed through a mill to obtain a desired particle size. The recycled and/or virgin plastic materials are provided in a form suitable for mixing with the natural materials, for example, in the form of a fluid, pellet, flake, powder, or the like. In certain embodiments, the particles are pre-densified before use. As will be discussed in more detail, in one embodiment, the composite material is manufactured having a board or panel geometry suitable for use as cross members and/or lead board members for the upper and/or lower deck of the pallet. In another preferred embodiment, the composite material is manufactured having a block or post geometry for use as supporting blocks that join the upper and lower decks to one another.

Typical press methods, if optionally used, rely on at least one press and include suitable pneumatic, mechanical and/or hydraulic presses that process wood/plastic mixtures into, for example, a block or a composite board. As is known in the art, a press typically includes an upper platen and a lower platen. At least one platen is driven upward or downward by a drive mechanism. A composite material assembly is positioned between the upper and the lower platens. A typical composite material press assembly may include a lower caul plate, a frame, the composite mixture and an upper caul plate. According to one embodiment of the present disclosure, at least one of the platens is heated to a temperature sufficient to melt the plastic component of the composite material. Heating of the platen(s) occurs optionally before or after engagement of the drive mechanism. In one embodiment, both platens are heated prior to application of pressure to the composite mixture. Preferably, the drive mechanism drives the lower platen upwards until the upper platen contacts the upper caul plate and compresses the composite mixture.

The plastic components of the composite material mixture may melt from the heat and disperse throughout the discontinuous wood phase. The composite material may essentially form a slurry of liquid plastic and wood particles. Preferably, air (and any other gas that may be present) exits the composite mixture during this process or it is alternatively compressed and trapped within the slurry. The slurry is typically of a density greater than that of the composite mixture and occupies a lesser volume than the mixture. The slurry may then be cooled and forms a relatively rigid composite product, such as a board. Rigidity and strength of the final product will depend upon the thickness, the type of plastic used, the ratio of natural and plastic materials, the amount and pressure of any entrained gas, and whether a reinforcing material, such as rods, bars, organic or inorganic continuous fibers, or a mesh, is incorporated into the slurry. It should be understood that caution is required when positioning the materials into the press to avoid segregation of the wood and plastic materials. Minimized segregation often forms a higher quality composite board.

In certain embodiments, any wood preparation methods and press and/or extrusion methods can be combined into one production process. For example, a wood receiver can be used for receiving wood that is transported to a screen for screening out undesirable larger pieces of wood. Once screened, the wood may be transported to a reducer for reducing the size of the screened wood. The reduced wood may be transported to a washer and/or screener that can optionally include a re-chipper for further reduction of the screened wood particle size. Next, the washed wood may be flaked using an appropriate flaker and transported to a flake receiver that optionally includes a heater and/or dryer and/or a dust burner. Flakes may then be transported to a grinder for grinding and/or sizing of the wood. The ground wood is then transported to a sifter for sifting fines from larger pieces of wood. Fines are transported to and stored in a fines receiver while the larger pieces are transported to and stored in a processed wood receiver. The fines receiver and processed wood receiver can optionally use filters. The processed wood and/or fines are then ready for further processing and/or combination with the recycled and/or plastic components.

Recycled and/or plastic materials typically enter the production process through a secondary receiver. The materials in a secondary loader are optionally transported to a storage receiver for storage and/or further processing. The storage receiver optionally includes a filter. Once the recycled and/or plastic material has been processed and/or stored, it is then transported to a measurement system, for example, a weigh station system and/or flow measurement system. The recycled materials, wood, and/or plastic may be transported to a blender for blending the components together. The blended components may be transported to a production line that includes a press and/or an extruder. The production line produces a final product or optionally has additional equipment for performing additional steps for producing the final product. For example, the production line can optionally include an unloader and/or cooler; at least one trimmer and/or borer; at least one transfer and/or inspection unit; a sander; a paint unit, for example, for spray painting (if desired); an oven, for example, for curing paint and/or other coating material; a grade station; and/or a stacker, for stacking product.

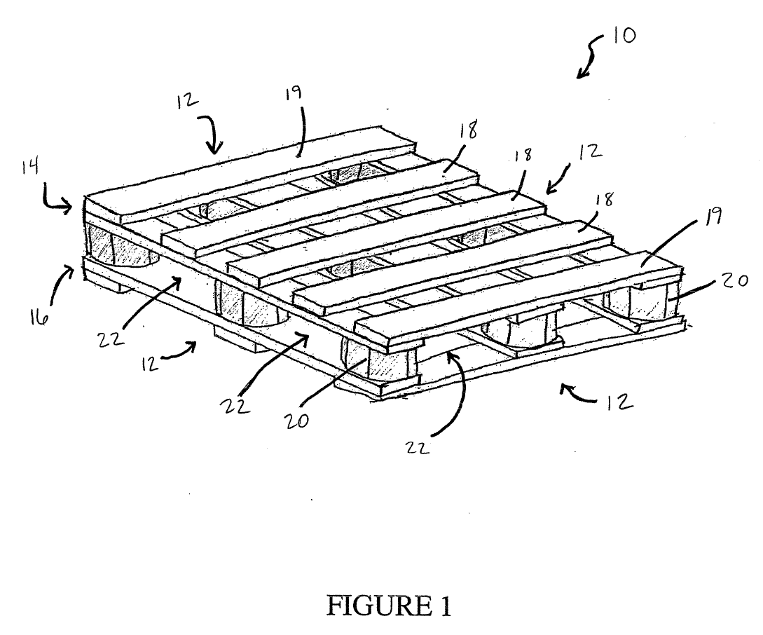

As shown in FIG. 1 and generally referenced by the number 10, the pallet of the present disclosure has four peripheral sides 12, or edges, defining the perimeter. Preferably each side 12 is disposed at a substantially right angle, thereby forming a rectangular shape. In one preferred embodiment, the pallet is constructed having the industry standard size and dimensions, which is currently 40 inches wide by 48 inches long (1.0 m by 1.2 m), although it may be made in any desired size or shape. The pallet 10 includes an upper deck 14 and a lower deck 16, each preferably being formed of a plurality of longitudinally and laterally extending cross members 18 and lead boards 19. As shown, the lead boards 19 may be the same size as the remaining cross members 18, or slightly larger to provide suitable additional strength. Preferably, they have dimensions of about 5½ inches wide, 40 inches long and 11/16 inches thick. Once assembled, the upper and lower decks 14, 16 are held together with a plurality of separating members, or blocks, generally referenced by the number 20.

As previously mentioned, at least one of the block members 20, and optionally certain cross members 18 of the decks, such as the lead boards 19, comprise the high strength composite material of the disclosure. For example, in certain embodiments, the block members 20 comprise the composite material, and the cross members 18 are standard wooden pieces. In other embodiments, the block members 20 and lead boards 19 comprise the composite material. In still other embodiments, each member of the pallet 10 can comprise the composite material. It should be understood that numerous combinations and designs incorporating composite material blocks 20 and composite board cross members 18 and lead boards 19 are possible, and all of the variations are within the scope of the disclosure.

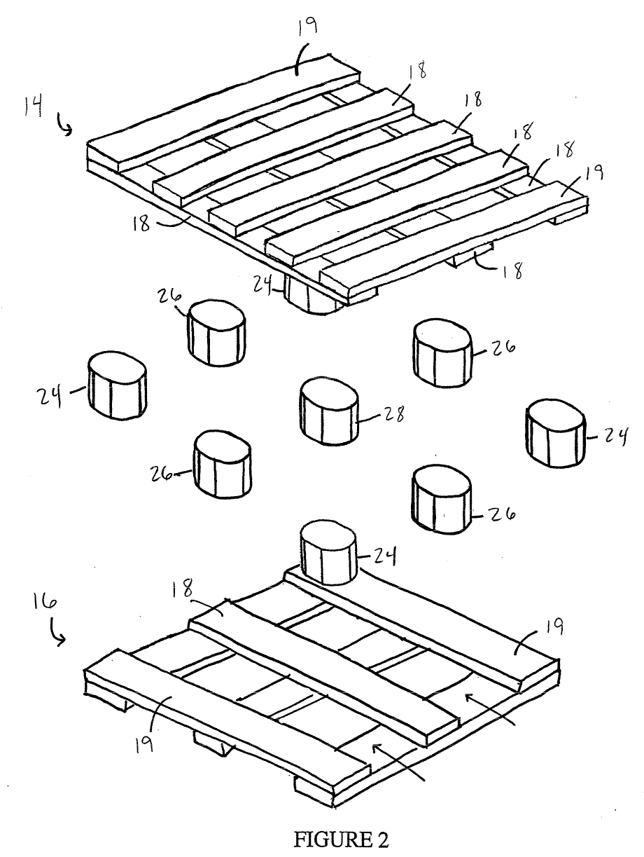

FIG. 2 depicts an exploded perspective view of the pallet 10 of FIG. 1, showing the individual components spaced apart from one another, and which comprise the upper deck 14, the lower deck 16, the cross members 18, and the plurality of blocks 20. Each block 20 holds the upper and lower decks 14, 16 together, while bearing and distributing the cargo loads placed on the upper deck 14. In preferred embodiments, the blocks 20 are mechanically fastened to the upper and lower decks, for example, with nails or screws. Preferably, there are nine blocks 20, aligned in three rows of three, defining two apertures 22 on each side 12 of the pallet 10. Ideally, each pallet has four corner blocks 24, four mid-side blocks 26, and one center block 28. The size of the apertures 22 will depend upon the size and length of the blocks 20.

In various embodiments, the upper deck 14 defines a generally planar load bearing surface upon which objects and goods may be positioned for transport and storage. The lower deck 16 defines a substantially planar bottom surface for the secure placement of the pallet on the ground or other resting surface. This also allows for the stable stacking of the pallet onto a similarly designed pallet. In certain embodiments, the upper and/or lower decks 14, 16 can comprise a continuous sheet of material (not shown). In these embodiments, a number of indentations and projections such as ridges and channels (not shown) may be formed in the top of the upper deck to allow for the drainage of any liquids that may accumulate thereon. Alternate embodiments may include further channels configured to direct fluid to the sides of the pallet if necessary. It should be noted, however, that the number, orientation, size and shape of any ridges or channels can be varied in many alternate configurations for optimized strength. Of course, the upper or lower deck 14, 16 may also have a continuous surface without apertures if so desired.

The load bearing surface may have a texture or an etched or imprinted geometrical pattern thereon (not shown) that acts as a non-skid surface to prevent objects from sliding during transport. Alternatively, any suitable type of friction tape or friction coating may be applied or laminated to the load bearing surface in order to help prevent movement of objects on the pallet. The final pallet assembly may additionally be embossed, silk screened, painted, or printed with indicia such as graphics, text, codes, brands, or the like if so desired.

Preferably, the lower deck 16 includes longitudinally and laterally extending cross-members aligned and connected to form a substantially rectangular shaped outer frame. As shown, one arrangement of the cross-members includes two relatively large apertures 38 allowing air flow through the pallet and also for accommodating pallet jacks. While shown as substantially rectangular in shape, the apertures 38 may be sized and shaped for other desired applications. Additional cross-members may be used, depending upon the desired load capacity of the pallet 10. In alternate embodiments, the size and number of apertures 38 will depend upon the placement and number of cross-members used.

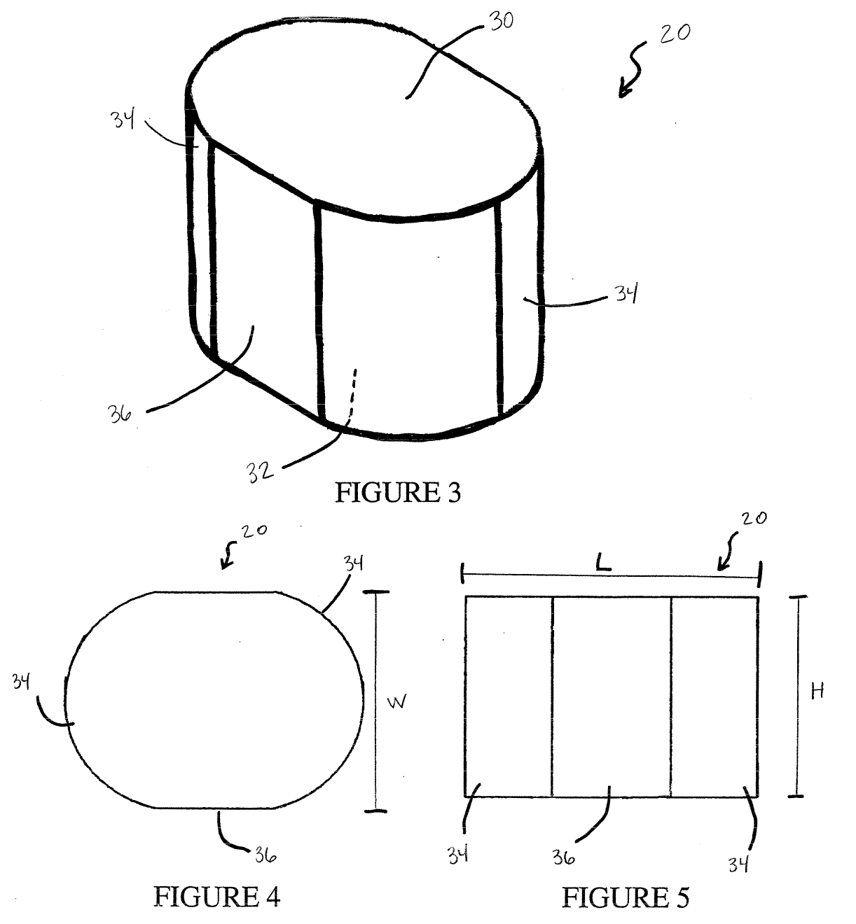

Preferably, the blocks 20 are of a sufficient size so that the apertures 22 define a space suitable for access by the tines, or forks, of a forklift truck or pallet jack from any of the four sides 12 of the pallet 20. The current industry standard is to have apertures 22 with a separation distance D of about 3.5 inches between the upper deck 14 and lower deck 16. Thus in one embodiment as shown in FIGS. 3-5, the blocks have a height H of about 3.5 inches, a width W of about 3.65 inches, and a length L of about 4.75 inches. For additional impact resistance, the blocks 20 may be provided with curved ends, thereby minimizing potential damage which may occur upon collision or brunt contact. Depending upon the specific composite material and desired strength, small to medium size blocks 20 may vary in weight from about 0.5 to about 5 lbs or more, and preferably from about 1 to about 2 lbs, or about 1.5 lbs. The blocks 20 may have a volume of from about 25 to about 75 in³ or more, and preferably from about 40 to about 60 in³, or about 55 in³. In other embodiments, it may be desirable to use larger scale blocks, for example having a volume of from about 75 to about 130 in³ or more, and preferably from about 110 to about 125 in³. These would typically have a weight of from about 4 to 5 lbs.

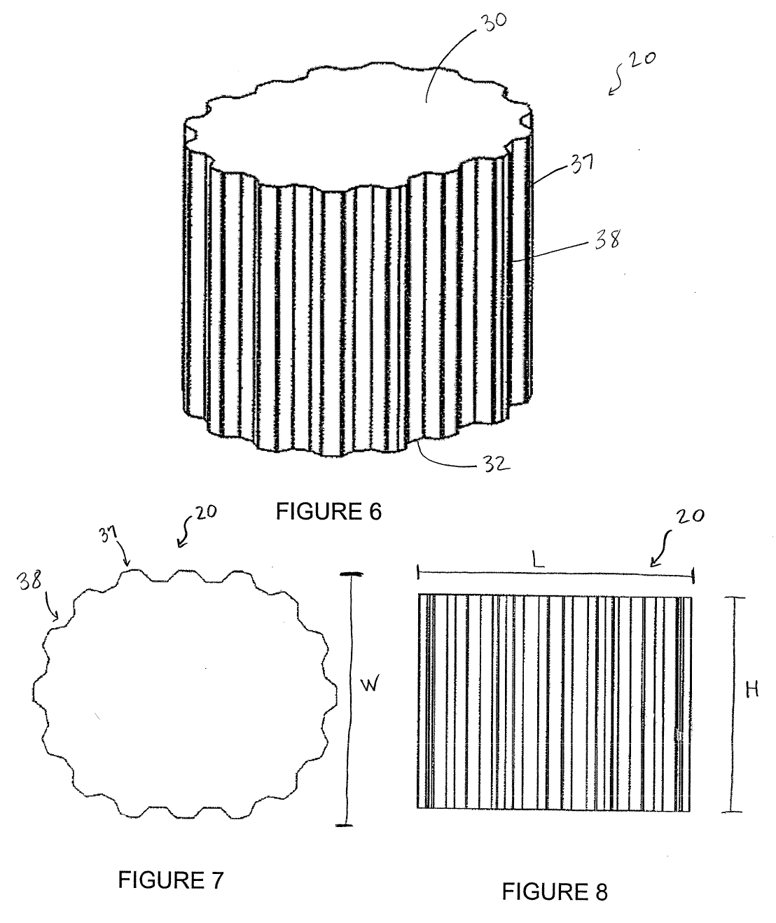

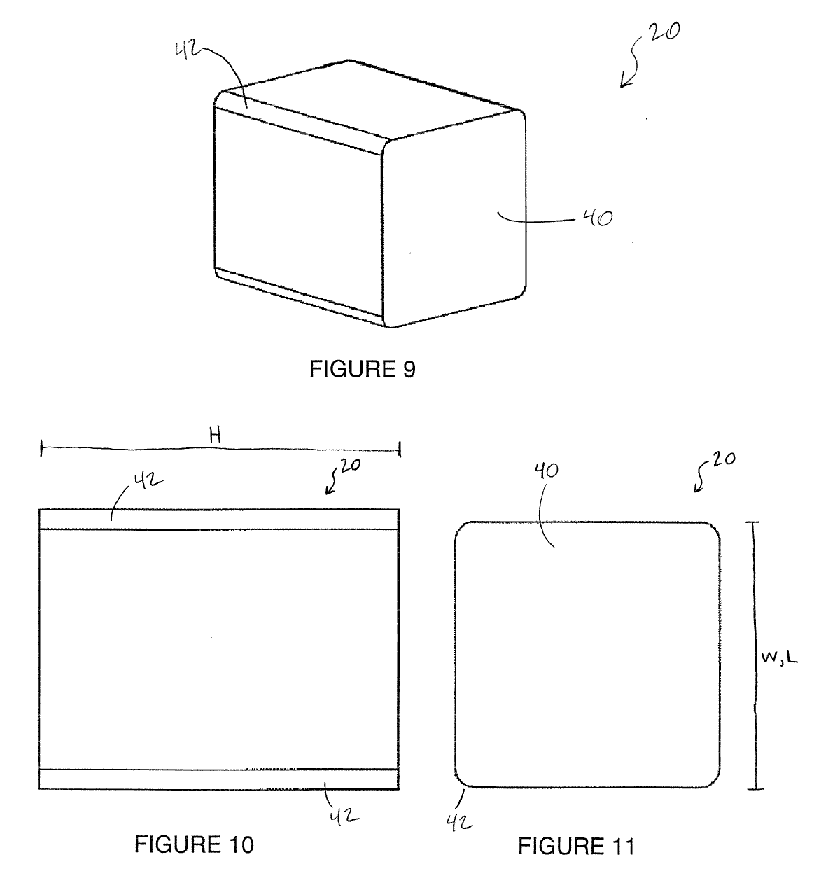

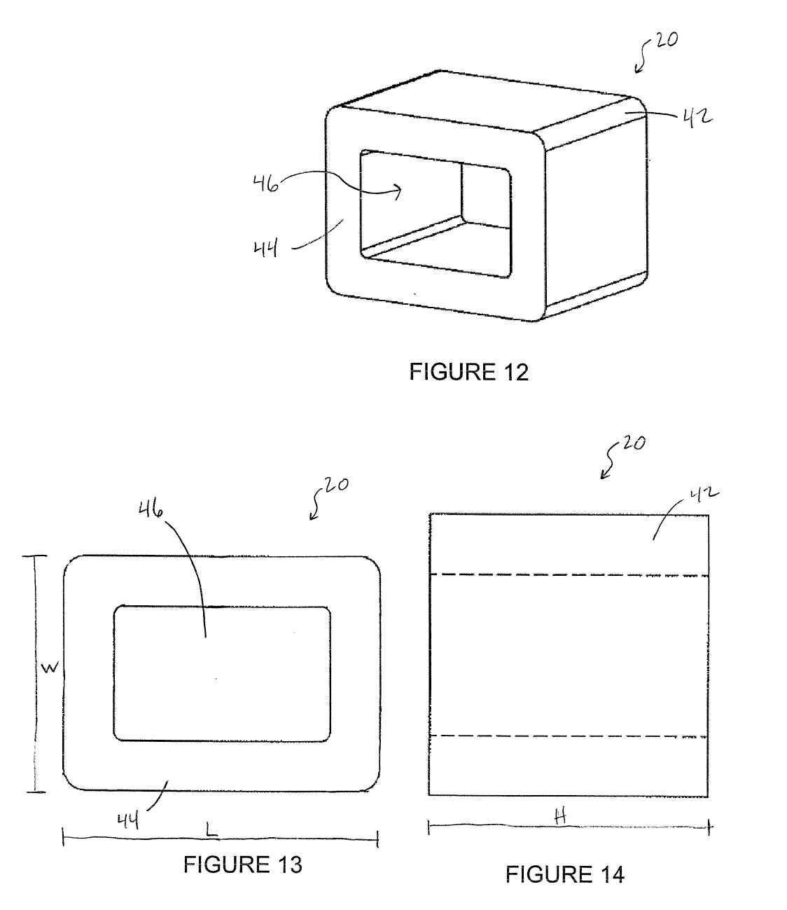

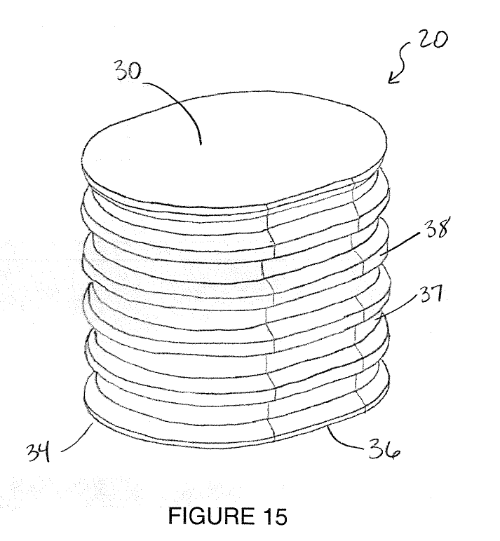

As shown in one non-limiting embodiment illustrated in FIGS. 3-5, the blocks 20 may have an elongated elliptical shape, including a planar top surface 30, a planar bottom surface 32, and two substantially circular side sections 34 sandwiching a substantially flat section 36. FIGS. 6-8 illustrate another embodiment of a block member 20 according to the present disclosure. As best shown in FIGS. 6 and 7, the block members 20 may be provided with a plurality of alternating vertical channels 37 and ridges 38. In various designs, the channels may have a depth of between about 0.05 to about 0.2 inches, while the number and width of the channels 37 and ridges 38 will vary based upon the total dimensions of the block member 20. FIGS. 9-11 illustrate still another embodiment of a solid block member 20 having a substantially square top 40 and cross-section with substantially rounded exterior corner areas 42. FIGS. 12-14 illustrate yet another embodiment of a hollow block member 20. As shown, the block member is provided with a substantially rectangular shaped top 44 with rounded corner areas 42 and having a hollow center area 46. FIG. 15 illustrates a variation of the embodiment of FIG. 6 and shows a block member having a plurality of alternating horizontal channels 37 and ridges 38. It should be understood that the specific size and shape of the composite block members 20 may be modified as necessary and desired, and variations of the overall size and shape are within the scope of the present disclosure.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A pallet comprising:
a first deck comprising a first plurality of cross members and a lead board;
a second deck comprising a second plurality of cross members; and
a plurality of block members connecting the first and second decks together to form a pallet, wherein at least one block member, a lead board, or at least one cross member comprise a composite material including natural material and a plastic material comprising a major portion of polyethylene.

2. The pallet according to claim 1, wherein the composite material comprises at least about 50% by weight of the natural material and at least about 45% by weight of the plastic material.

3. The pallet according to claim 1, wherein the plastic material comprises at least one material selected from the group consisting of polypropylene, polyethylene, polyurethane, polyvinylchloride, poly(ethylene terephthalate), nylon, and mixtures thereof.

4. The pallet according to claim 1, wherein the block members further comprise at least one filler selected from the group consisting of colorants, UV protectors, flame and fire retardants, lubricants, soaps, polymer initiators, coupling agents, and mixtures thereof.

5. The pallet according to claim 1, wherein the natural material particles comprise ground particles of whole trees selected from the group consisting of junipers and conifers, the whole trees including root particles, trunk particles, branch particles, needle particles, wood particles, and mixtures thereof.

6. The pallet according to claim 5, wherein the natural material particles comprise at least one wood selected from the group consisting of: Apache Plume; Ash, single-leaf; Bitterbrush; Cliffrose; Fendlerbush; Juniper, one-seed; Juniper, rocky mountain; Mahogany, curl-leaf; Mahogany, mountain; Mock Orange; Ponderosa Pine; Mormon Tea; and mixtures thereof.

7. The pallet according to claim 1, wherein at least one of the first and second decks comprises a substantially rectangular frame having a plurality of longitudinally and laterally extending cross members, further wherein at least one of the plurality of cross members comprises a composite material comprising at least about 20% by weight of natural material particles ground from whole trees.

8. The pallet according to claim 1, wherein the block members further comprise at least one filler selected from the group consisting of colorants, UV protectors, flame and fire retardants, lubricants, soaps, polymer initiators, coupling agents, and mixtures thereof.

9. The pallet according to claim 1, wherein the block members have an average water absorption of less than about 15% by weight.

10. The pallet according to claim 1, wherein the natural material particles have an average particle size of less than about 0.25 inches and have a random orientation in the composite material.

11. The pallet according to claim 10, wherein the natural material particles have an average particle size of less than about 0.0625 inches.

12. A method of making a pallet member, the method comprising:
receiving wood particles on a screen and screening out wood particles of a given size;
transporting the screened wood particles to a reducer and reducing the size of the screened wood particles;
transporting the wood particles to a washer for washing the wood particles;
flaking the washed wood particles;
grinding the washed wood particles and storing the wood particles in a processed wood receiver;
storing plastic material in a plastics receiver;
transporting the plastic material from the plastics receiver and the wood particles from the wood receiver to a blender for blending the plastic material and wood particles; and
using heat and pressure to form the blended wood particles and plastic material into a pallet component.

13. The method of claim 12, comprising extruding the blended wood particles and plastic material into a pallet component.

14. The method of claim 12, wherein the blended wood particles and plastic material are pressed together into a pallet component.

15. The method of claim 12, comprising providing wood particles including ground particles of whole trees selected from the group consisting of junipers and conifers, the whole trees including root particles, trunk particles, branch particles, needle particles, wood particles, and mixtures thereof.

16. The method of claim 15, wherein the wood particles comprise at least one wood selected from the group consisting of: Apache Plume; Ash, single-leaf; Bitterbrush; Cliffrose; Fendlerbush; Juniper, one-seed; Juniper, rocky mountain; Mahogany, curl-leaf; Mahogany, mountain; Mock Orange; Ponderosa Pine; Mormon Tea; and mixtures thereof.

17. A method of making a pallet, comprising:
preparing and blending a mixture comprising from about 50% to about 55% by weight of natural material particles and from about 45% to about 50% by weight of plastic material particles;
heating and extruding the mixture using a continuous extrusion process forming a composite material of a desired shape;
cutting the composite material into block members and boards; and
securing the blocks and boards with nails or screws to form a pallet having substantially rectangular shaped upper and lower decks.

18. The method of claim 17, comprising providing wood particles having an average particle size of less than about 0.25 inches and include ground particles of whole trees selected from the group consisting of junipers and conifers, the whole trees including root particles, trunk particles, branch particles, needle particles, wood particles, and mixtures thereof.

19. The method of claim 17, comprising providing the plastic material selected from the group consisting of polypropylene, polyethylene, polyurethane, polyvinylchloride, poly(ethylene terephthalate), nylon, and mixtures thereof.

20. The method of claim 17, comprising providing the blocks members and boards having an average water absorption of less than about 15% by weight.
